(19) United States
(12) Patent Application Publication
(10) Pub. No.: US 2004/0230457 A1
(43) Pub. Date: Nov. 18, 2004

(54) Handheld medical reference application with integrated dosage calculator

(76) Inventors: Mark Rosenbloom, Evanston, IL (US); Karen Jeffrey, Chicago, IL (US)

Correspondence Address: WELSH & KATZ, LTD, 120 S RIVERSIDE PLAZA, 22ND FLOOR, CHICAGO, IL, 60606, US

(21) Appl. No.: 10/764,980

(22) Filed: Jan. 26, 2004

Related U.S. Application Data
(60) Provisional application No. 60/442,538, filed on Jan. 24, 2003.

(51) Int. Cl. G06F 17/60

(52) U.S. Cl. 705/2

(57) ABSTRACT

A medical information device may include a general purpose computer such as a handheld computer, configured with a plurality of medical and drug information content pages and a reader application configured to display the medical and drug information content pages. To access the drug and medical information content pages, the reader may generate a plurality of parameter strings in response to user-selected medical and drug information. The medical information device may also include a drug dosing calculator application configured to receive at least one of the parameter strings generated by the reader application and to return dosing information to the reader application. The parameter string or strings may include drug dosing parameters corresponding to a user-selected medical condition and a user-selected drug and/or drug dosing parameters corresponding to medical and drug information included on a selected medical and drug information content page. The medical information device may also include a general medical calculator application configured to receive at least one of the parameter strings generated by the reader application and to return appropriate calculated results to the reader application.

### BACKGROUND

This application claims the benefit of U.S. Provisional Application No. 60/442,538, filed Jan. 24, 2003.

This invention relates to medical information devices and methods for using medical information devices to assist in the diagnosis, care, and treatment of patients.

The amount of information that a healthcare professional must have at his or her disposal to diagnose and treat patients can be daunting. Healthcare professionals are overloaded with information needed to provide the best care for patients. Standards of care are rapidly changing for hundreds of medical conditions. There are thousands of drugs each with unique side-effect profiles and tens of thousands of drug interactions, many of these potentially fatal. Dosages for medications must be calculated carefully, and may depend on the patient's age, weight, body surface area, or other criteria. Also, dosages and/or calculation formulae may vary with the purpose of the medication (e.g., anesthesia or sedation), the condition being treated, and the method of administering the medication (e.g., oral or intravenous). Also, healthcare professionals may need to perform dozens of other medical related calculations a day, such as those relative to fluid and nutritional requirements, calculating electrolyte imbalances, and organ function metrics (e.g. cardiac output).

To provide effective care for a patient, today's healthcare professional needs a portable, comprehensive, integrated medical and drug information resource that can instantly provide him or her with essential information and calculations at the bedside. The device should also be capable of updating the medical and drug information.

### SUMMARY

The PEPID medical reference application allows medical professionals and non-professionals to accurately and quickly search for medical or drug reference information stored in PEPID content files on handheld devices. A handheld device configured with the medical reference application is referred to herein as a medical information device. This product allows users to navigate through a hierarchical representation of medical and drug information on handheld devices and gain access to a variety of complementary applications. The complementary applications include, for example, an integrated drug dosage calculator. While the benefits of the invention are most likely to be achieved with the portability afforded by a handheld computer, such as a Palm OS or Windows Pocket PC device, the invention may also be implemented on other computing devices, such as laptop and desktop computers.

A medical information device may include a general purpose computer such as a handheld computer, configured with a plurality of medical and drug information content pages and a reader application configured to display the medical and drug information content pages. To access the drug and medical information content pages, the reader may generate a plurality of parameter strings in response to user-selected medical and drug information. The medical information device may also include a drug dosing calculator application configured to receive at least one of the parameter strings generated by the reader application and to return dosing information to the reader application. The parameter string or strings may include drug dosing parameters corresponding to a user-selected medical condition and a user-selected drug and/or drug dosing parameters corresponding to medical and drug information included on a selected medical and drug information content page.

The medical information device may also include a document manager application, configured to receive the plurality of parameter strings generated by the reader application and to provide medical and drug information content pages to the reader application. The document manager application may be configured to manage an integrated medical and drug information database, including updating and controlling access to medical drug information content pages. The document manager application may be configured to allow access to medical drug information content pages only during the time period of a user subscription.

The medical information device may also include a unit conversion calculator configured to receive at least one of the parameter strings generated by the reader application and to return converted units to the reader application. The medical calculator device may also include a generic calculator that is resident in the document manager application and is linked to calculator definition database and calculator lookup tables to provide calculator definitions.

A method for calculating drug dosing using a medical information device may include the steps of configuring the computing device with medical and drug information content pages and a drug dosing calculator, displaying at least one medical and drug information content page on the computing device, selecting a medical condition from a plurality of medical conditions displayed on the computing device based on observations of a patient and displayed medical information, selecting a drug from a plurality of drugs displayed on the computing device, passing drug dosing parameters corresponding to the selected medical condition and the selected drug to the drug dosing calculator, and displaying a calculated drug dose. An additional step may include selecting a method of administering the selected drug and wherein the drug dosing parameters further includes parameters corresponding to the selected method of administering the drug.

### DESCRIPTION OF THE DRAWINGS

FIG. 1 is a block diagram of a medical information device corresponding to an example of the present invention.

FIGS. 2a and 2b comprise a table of examples of parameter strings that may be generated by the reader application.

FIG. 3 is a block diagram of a generic calculator corresponding to one aspect of the present invention.

### DETAILED DESCRIPTION

1 Medical Reference Application and Document Manager Application.

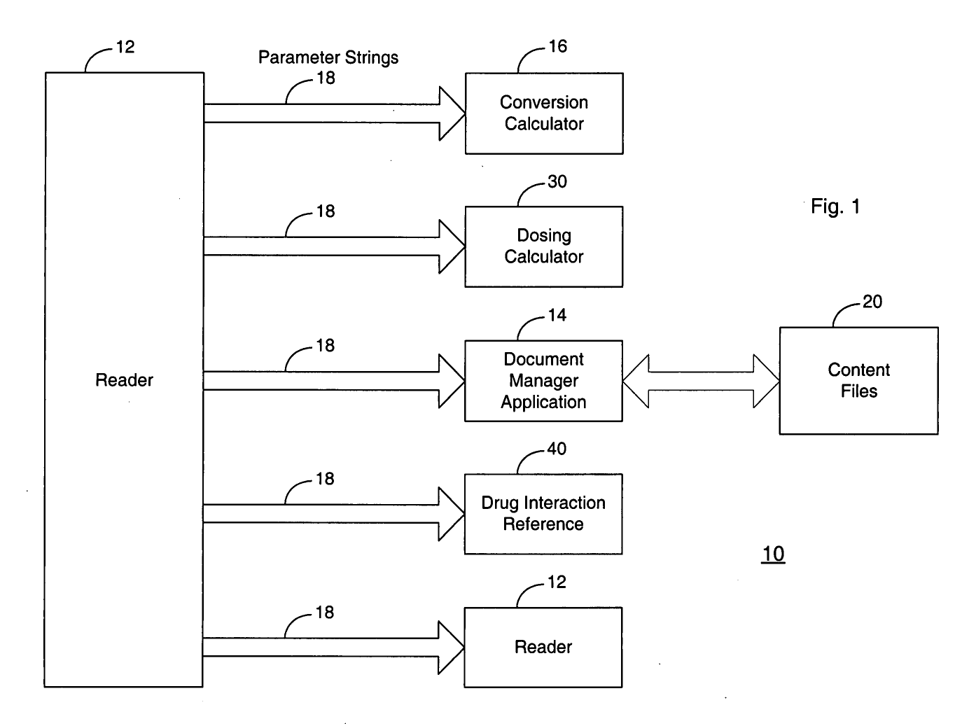

In an example illustrated in FIG. 1, a medical reference device 10 comprises a sending application 12 associated with content files 20 and further associated with a plurality of receiving applications by defined links. The receiving applications may further be associated with one or more databases. In one example, the sending application 12 is a document reader. The Reader may comprise an application configured to read hypertext mark-up language (HTML) or extensible markup language (XML) documents. In one example, the Reader may be an open-source browser. The receiving applications may include a Document Manager Application (DMA) 14 and one or more calculators, which may include unit conversion calculators 16 and drug dosing calculators 30. Also, the use of calculators in this document is not necessarily limited to mathematical calculations. A calculator as used herein may perform non-mathematical functions, such as drug interaction comparisons.

One feature of the PEPID medical reference device is a high level of integration of a reader (sending application) 12 with an assortment of complementary applications. The integration is achieved by providing the capability to pass predefined data parameters 18between the applications. The medical reference device has a standardized application programming interface mechanism that enables it to easily add any number of integrations to complementary applications, including an assortment of handheld medical calculators and a drug interaction reference. The integration is performed by defining links 18 between the sending application and the receiving applications. The Reader 12 may be configured to pass parameters to the receiving applications.

The Reader 12 may be associated with one or more content files 20. Content files may be provided as a single file that includes a plurality of “reference cards”, or pages of information, provided in an encrypted handheld database or file store format. The reference cards may number in the hundreds or thousands. Multiple content files may also be accessed and managed on a single medical reference device 10. Content is organized hierachically, usually by medical sub-specialty and drug category, providing the most efficient method for accessing medical information. These content files may authored in HTML files and processed by an application script that converts the HTML content into handheld database formats for viewing within the Reader 12.

In one example, the Reader 12 includes tabs or icons for selecting an index, a table of contents, and conversion equations for a content file. Examples of content files 20 may include files for assisting physicians to diagnose illnesses or injuries. Others may include files for drug information. In one example, a table of contents for the PEPID Portable Drug Companion is reproduced below:

PEPID PDC

Portable Drug Companion

Table of Contents

Drugs

Toxicology

Conversion Equations

About PEPID PDC

Warning

Drugs

Anesthesia

Cough & Cold Preparations

Dermatology

Eye/ENT

Gastrointestinal

Heart/Vascular

Vitamins & Minerals

Herbs & Food Supplements

Anti-Infectives

Metabolic & Endocrine

Hematology & Oncology

Neurological Agents/Psychiatry

Obstetrics & Gynecology

Pain

Immune Agents & Misc. Drugs

Vaccinations & Immunizations

Drug Interactions

Canadian Drug Trade Names

Toxicology

General

Toxin Identification

Poison Control Centers

Drugs of Abuse

Household Items

Plants

Inhaled Toxins

Hazardous Materials

Overdoses

Antidotes

Other

Conversion Equations

SI Units

Distance

Weight

Temperature

Pressure

Volume

Age Related Tables

Each of the entries in the table of contents may be linked to further information on the topic. For example, selecting “Anesthesia” links to the following information:

Anesthesia Drugs

Induction Agents

Premedication

General Anesth.

Paralysis

Miscellaneous

Induction Agents •Methohexital (Brevital)

Thiamylal (Surital)

Thiopental (Pentothal)

Premedication •Atropine (Atropine)

Glycopyrrolate (Robinul)

General Anesthetics •Desflurane (Suprane)

Etomidate (Amidate)

Ketamine (Ketalar)

Propofol (Diprivan)

Sevoflurane (Ultane)

Neuromuscular Blockers (Paralysis) •Neuromuscular Blockers Drug Interactions

Atracurium (Tracrium)

Botulinum Toxin (Botox, Myobloc)

Doxacurium (Numorax)

Mivacurium (Mivacron)

Pancuronium (Pavulon)

Rapacuronium (Raplon)

Rocuronium (Zemuron)

Succinylcholine (Anectine)

Vecuronium (Norcuron)

Misc. •DPT Combination DemerolVPhenergan/Thorazine

Selecting one of the listed drugs, Thiopental, for example, may lead to the following information:

[TOPICS][INRX]

Thiopental (Pentothal)

Dosing

Adult: •3-5 mg/kg IVP+/−infuision

Cerebral edema: 1.5-5 mg/kg IV ×1 dose

Anesthesia: •Induction: 2-6 mg/kg IV ×1 dose

Maint.: 50-100 mg IV PRN

Neurosurgical pts with incr ICP: 1.5-3.5 mg/kg IV with proper ventilatory support

Convulsive states: 75-125 mg IVP

Peds: •See adult dose; administration based on pt response

Deep sedation: 30 mg/kg PR ×1 dose ; NMT 1 g/dose

Dosage forms: [20 mg/mL, 25 mg/mL]; 800 mg/2 g rectal suspn

Indications

Depresses CNS to produce hypnosis, anesthesia & retrograde amnesia WITHOUT analgesia

In high dose, may be used to reduce ICP, and depress cerebral metabolism

C-Ind

Lack of ventilatory support, porphyria, hypotension

ADR's

Cardiovascular depression, hypotension, arrhythmias, arrest, laryngospasm, apnea, salivation

CAUTION: rapid bolus doses will increase cardio-respiratory effects: laryngospasm, apnea, hypotension, myocardial depression, cardiovascular collapse

Pregnancy Category: C

Kinetics

Hepatically conjugated to inactive metabolites, excreted in urine; 3-6 hr t1/2

Onset: 30-60 sec

Duration: 20-30min

Additive/synergistic effects if administered with or following an opioid, sedative or inhalational anesthetic agent

Slow release of this drug from lipoidal tissue result in prolonged anesthesia, somnolence, and respiratory and cardiovascular depression

Mechanism of Action

Baribiturate; no musc. relaxant activity

Overdose Management

See Barbiturate OD

Interactions

Anesthetics: “incr thiopental” [anesthetics generally incr levels or activity of thiopental]

Narcotics: incr thiopental

Phenothiazines: incr thiopental

Probenecid: incr thiopental

Sulfisoxazole: incr thiopental

Sedatives: incr thiopental

The dosage information may be linked to an integrated dosage calculator 30 by one or more linking icons. Each linking icon may cause the Reader to pass different parameters to the dosage calculator 30 for a single drug. With respect to the above example for Thiopental, selecting Adult, Cerebral edema, Anesthesia, and Deep sedation would each pass a different parameter to the dosage calculator.

In one example, the medical reference device 10 is secured via application code, and a registration code is required in order to access the PEPID content files. The Document Manager Application DMA 14 provides functionality for users to register, activate, access and manage one or more PEPID content files for which they have subscribed or purchased. The DMA 14 provides the ability to access this medical and drug reference information as a result of a one-time purchase or a time-specific subscription period. Subscription periods can be set for any length of time, including an unlimited time period. This subscription period is used by the DMA 14 to control access to the content files 20 allowing access while in the subscription period, and restricting access while outside of the subscription period. Additionally, the DMA 14 provides the ability to access content files 20 during an automatically expiring trial period with no registration or subscription information required.

The DMA 14 provides the ability to access and manage content files in either a handheld device's primary memory or on detachable expansion memory media, i.e. CF cards, SD cards, Memory Sticks, etc., inserted into the device. In addition to handheld devices, the medical reference application may be used on desktop or laptop computers, with files stored in disk drives or other suitable storage.

Content and application files may be delivered to users via one of several delivery options, including electronic delivery over the internet and CD ROM, and are ultimately installed to the end users' handheld devices via the synchronization method provided by their device manufacturer. Users have the ability to install the content files 20 to the handheld device's main memory or to expansion memory. Users also have the ability to install content files 20 to a desktop or laptop computer.

Upon accessing the medical reference device 10 users are provided a list of content files 20 loaded on their device. For each content file located on the handheld device, users have the option to register the file, open the file, delete the file, or copy the file to expansion memory. In addition to content file-specific functionality, users have the ability to remove all PEPID applications associated with the medical reference application and content from the handheld device.

From the DMA 14, users are provided a variety of system messages. These messages vary depending upon several factors, including the current state of the subscription and registration, including triggers for when registration has not occurred, when the subscription is about to expire, and when the subscription has expired, and when system errors are detected. Messages appear in two formats, either within the primary DMA screen or within a pop-up dialog box.

Upon accessing a content file 20 via the DMA 14, users enter the Reader (sending application) 12. Within the Reader 12, users may browse through content via icons and text-based links, either navigating to another content card or launching a complementary application, such as one of the medical calculators 16, 30. Navigation features include selecting icons or text-based links, moving back and forward along the recent navigation history, jumping to the top or bottom of the page, selecting from a dynamic navigation list to “quick jump” to sections on the page, accessing the table of contents, and accessing a database driven index.

Within the Reader 12, users may create bookmarks to mark a content location for later reference. Users may also copy any content page to a text file for printing or use in another electronic application.

2 Handheld Medical Calculators

2.1 Drug Dosing Calculator

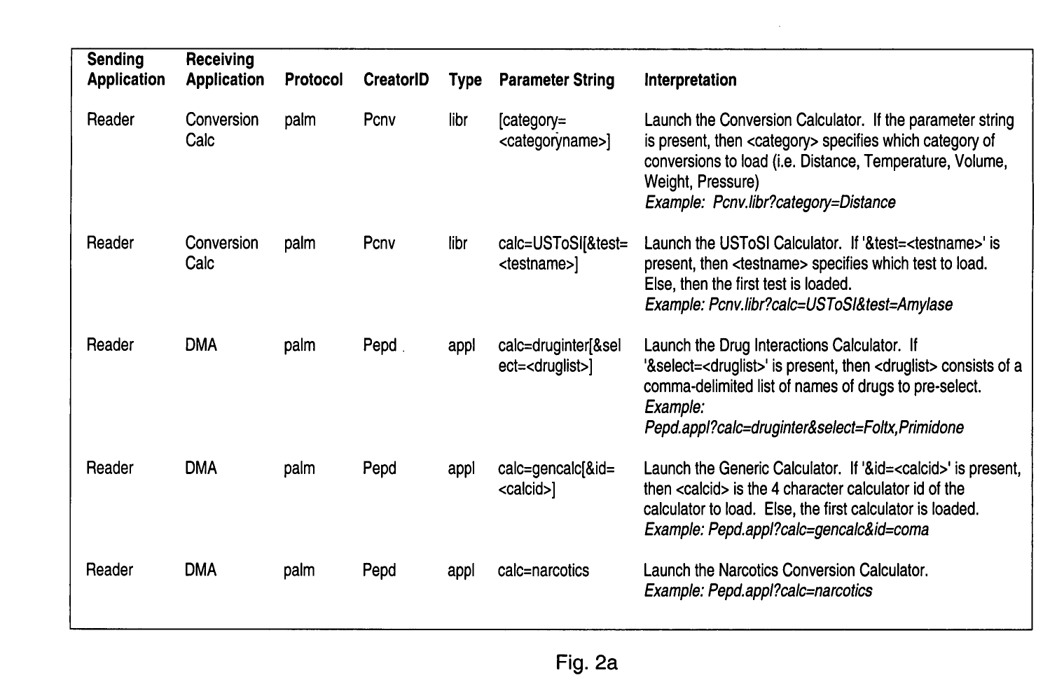

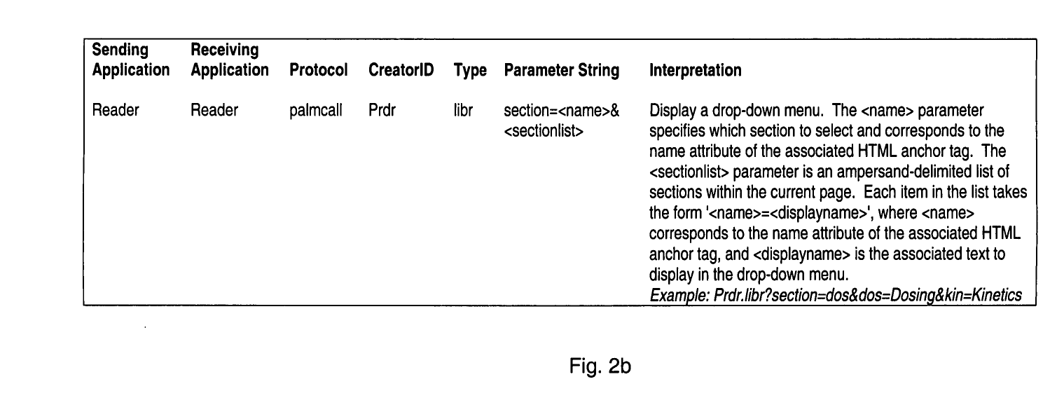

The Drug Dosing Calculator 30 is application that enables users to calculate weight-based, body-surface-area-based and age-based drug dosing amounts. The calculator is accessed via a link within an icon- or text-based link 18 within a content page in the Reader 12. The link 18 closes the Reader application 12 and launches the Drug Dosing Calculator 30. All applicable parameters are passed between the two applications to enable true integration. FIG. 2 illustrates some examples of parameter strings. The parameters may be dependent on a specific condition being viewed in the Reader 12. For example, a dosage parameter for a given drug may differ for different illnesses.

The Drug Dosing Calculator 30 accepts a parameter from the Reader 12 identifying the appropriate drug for which a dosing calculation is desired. Upon entering the Drug Dosing Calculator 30, the application dynamically determines if the drug dosing calculation is weight-based, body-surface-area-based, and/or age-based, prompting the user for the appropriate patient-specific value in several available units of measure. For weight-based and surface area-based dosing calculations, the user has the option to calculate an estimate of the patient's weight or surface area, respectively. Upon entering or estimating the input value, the calculator proceeds to calculate the appropriate drug dosing amount based on the inputs. The user is presented with the formula used to calculate the dosing, the drug dosing amount in the applicable standard unit, the frequency and duration of dosing, and conversions into liquid-based dosing for standard concentration formulas. Additionally, the calculator automatically checks that all input values fall within acceptable ranges and that the final recommended dosing falls within acceptable minimum and maximum amounts.

2.2 General Description of External Link Functionality

In one example of linking a Reader 12 to a calculator, external links 18 within the documents take the following form:

<a href=“protocol:creatorid.type?params”. . . >

where

| | |
|---|---|
| protocol = | palm \| palmcall |
| creatorid = | 4 character PalmOS creator id of the application to |
| | launch |
| type = | PalmOS type of the application to launch |
| params = | the parameter string |

The use of the “palm” protocol indicates that the Reader 12 should quit and launch the UI application specified. The use of the “palmcall” protocol indicates that the Reader 12 should launch the specified application as a subroutine. In either case, the Reader 12. will launch the target application using the sysAppLanchCmdURLParams PalmOS launch code. This launch code is accompanied by a parameter block consisting of the parameter string above.

2.3 Unit Conversion Calculator

The Unit Conversion Calculator 16 is a complementary application that enables users to calculate standard unit conversions for weight, distance, volume, temperature, and pressure. The Unit Conversion Calculator 16 accepts a parameter from the Reader 12 identifying the appropriate conversion category. Users enter a single input value for the value to convert, select the applicable unconverted and converted units of measure, and calculate the converted value.

2.4 US to SI Unit Conversion Calculator

The US to SI (Standard International) Unit Conversion Calculator is a complementary application that enables users to quickly convert results for various standard medical test results from the standard units used in the United States to those units used internationally, and vice versa. The US to SI Unit Conversion Calculator accepts a parameter from the Reader identifying the appropriate test result to convert. Users enter a single input value, either the US or SI value, and calculate the other. The Unit Conversion Calculator is linked in a manner similar to Conversion Calculator 16, and is not separately illustrated.

2.5 Configurable Handheld Medical Calculator Application

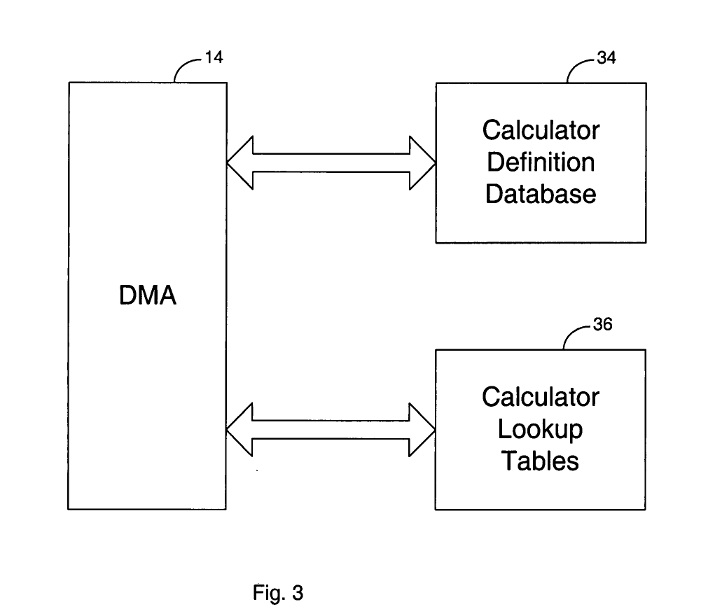

The Configurable Handheld Medical Calculator Application 32 (FIG. 3) is a complementary application that enables administrators of the application to define parameters for a medical calculation within an XML definition, which are then converted into a handheld database and interpreted within the Configurable Handheld Medical Calculator application in order to produce an unlimited number of medical calculators.

Calculations that meet the following criteria can be configured to function within the application without any programming required:

All input values are numeric, dates or lists where each item can be converted to a numeric value.

Require at least one input value.

Results can be calculated via a mathematical formula, i.e. no conditional logic within the calculation.

The defined medical calculations are processed in an application that enables users to enter multiple input values, enter values in a variety of units of measure, calculate a formulaic result, and validate all inputs and results against pre-defined minimum and maximum allowable values.

In one example Configurable Handheld Medical Calculators application consists of three parts:

A handheld application/GUI, which is integrated into the PEPID DMA 14.

A Calculator Definition Database 34 containing the calculator definitions.

Calculator Look-up Tables 36 containing the lookup tables for any and all calculators defined in Calculator Definition Database 34.

In addition, the application requires three files to be used to generate the two databases above:

A script to generate databases

A Generic Calculator Document Type Definition (DTD)

An XML file containing calculator definitions (calculator definition file)

To generate the two databases above, users execute the script, which references the DTD and XML file to create the two required handheld databases.

In the calculator definition database 34, users can define an unlimited number of medical or non-medical calculators. The calculator definition database 34 must conform to the Generic Calculator DTD. The DTD specifies what XML elements (markup tags) are allowed, what XML elements are required, and how the XML elements can be nested. The DTD also specifies the attributes that may be provided for each element and what attributes may be omitted for each element. The basic structure for the calculator definition file is as follows:

<?xml version=“1.0” encoding=UTF-8”?>

<!DOCTYPE gencalc SYSTEM “gencalc.dtd”>

<gencalc>

</gencalc>

Where one or more <calculator> elements are nested within the <gencalc> element for each calculator. Users must nest one calculator element within the <gencalc> element for each calculator. The syntax of the <calculator> element is shown below with required attributes in italics.

<calculator id=‘[4 character string]’ >

</calculator>

where the <calculator> element attributes are defined as follows:

id A 4-character ID that is unique amonge <calculator> elements.

Exactly one occurrence of each of the following elements must be nested within the calculator element:

```
<title>[text]</title>
  [text] The name of the calculator.
<rpn>(text)</rpn>
  (text) RPN equation. See details below.
<indexkeyword>[text]</indexkeyword>
  [text] (Start of) the keyword to highlight when launching the Index.
<shortcomment>[text]</shortcomment>
  [text] Short comment to display below the result field.
<longcomment>[text]</longcomment>
  [text] Long comment to appear in the popup comment form.
<result>[child elements]</result>
```

see details below.

In addition, one or more occurrences of the following elements must be nested within the calculator element:

<input>[child elements]</input>

See details below.

In one example, users must nest one and only one <rpn> element within each calculator element:

<rpn>(text)</rpn>

Where (text) is an equation specified in reverse polish notation that contains variables, operators, and numeric values.

Allowed Variables:

[a, p] where each character is mapped to the<input> element whose ‘var’ attribute value is equal to the character, allowing a maximum of 16 variables/inputs.

Allowed Operators:

+, −, *, and \hat{ }, which specify addition, subtraction, multiplication, division, and exponentiation, respectively.

### EXAMPLE 1

You have four inputs (a, b, c, d), which are to be used in the following equation specified in infix notation: (a+b)/(1 −(c+d)). The appropriate <rpn> element definition would be:

<rpn>a b+1 c d+−/</rpn>

### EXAMPLE 2

You have four inputs (a, b, c, d), which are to be used in the following equation specified in infix notation: (a \hat{ }b) +(c •d). The appropriate <rpn> element definition would be:

<rpn>a b\hat{ }c d*+</rpn>

Users must nest one and only one <result> element within each calculator element. The syntax of the <result> element is shown below with required attributes in italics.

<result name=‘[text]’>

</result>

where the<result> element attributes are defined as follows:

name The displayed name/label of the result.

The first child element nested within the <result> element specifies what to do with the numeric result computed by the RPN equation. Valid child elements are shown below with required attributes in italics.

<int min=‘. . .’ max=‘. . .’ default=‘. . .’ />

Format the computed result as an integer.

<float min=‘. . .’ max=‘. . .’ sigdigits=‘. . .’ default=‘. . .’ />

Format the computed result as an floating point number.

<date/>

Format the computed result as a date.

<lookup>

<interval. . ./>

</lookup>

Look up the computed result in the associated lookup tables. Lookup tables are defined by nesting one or more <interval> elements.

The attributes shown for the tags above are interpreted as follows:

default Ignored/unused.

min: Minimum allowed value (empty value=negative infinity).

max: Maximum allowed value (empty value=positive infinity).

sigdigits Number of significant digits to use when formatting the result. The default number of significant digits is 4.

Each <interval> element nested within a <lookup> element specifies a lookup interval. The syntax of the <interval> element is show below with required attributes in italics.

<interval min=‘[numeric]’ max=‘[numeric]’ value=‘[string]’/>

Where the attributes for the <interval> element are interpreted as follows:

min: Minimum interval value (empty value=negative infinity).

max: Maximum allowed value (empty value=positive infinity).

value The value to display if the result falls within the interval [min, max].

If the first child element is an<int>, <float>, or<date> element, then you may also nest a single <staticunit> or <dynamicunit> element within the <result> element. If the first child element is a <lookup> element, then you may also nest a single <staticunit> element within the <result> element.

Users must nest one <input> element within each <calculator> element for each of the calculator input values. The syntax of the <input > element is shown below with required attributes in italics.

<input name=‘[text]’ var=‘[single character]’ >

</input>

where the <input> element attributes are defined as follows:

| | |
|---|---|
| name | The displayed name/label of the input. |
| var | The associated input variable that appears in the RPN |
| | equation that is unique among <inputs> elements within |
| | each <calculator> element. |

The first child element nested within the <input> element specifies the type of the input to be entered by the user. The valid child elements are shown below with required attributes in italics:

<int min=‘. . .’ max=‘. . .’ default=‘. . .’ />

The input must be an integer value.

<float min=‘. . .’ max=‘. . .’ sigdigits=‘. . .’ defautl‘. . .’ />

The input must be a floating point value. <date/>

The input is a date.

enum default=‘[integer]’ >

<option. . ./>

</enum>

The input is an enumeration (popup list). Options in the popup list are defined by nesting one or more <option> elements.

The attributes shown for the tags above are interpreted as follows:

min: Minimum allowed value (empty string=negative infinity).

max: Maximum allowed value (empty string=positive infinity).

sigdigits Number of significant digits to use when formatting the results of conversions between values. The default number of significant digits is 4.

default For <int> and <float>, this is the default value to be displayed.

For <enum>, this is the default option to select. Each <option> element nested within an <enum> element specifies an option in the popup list. The syntax of the <option> element is show below with required attributes in italics.

<option value=‘. . .’ label=‘. . .’/>

where the attributes for the <option> element are interpreted as follows:

| | |
|---|---|
| value | The value to use in the RPN equation when this option is selected. |
| label | The associated text to display in the popup list. |

If the first child element is an <int>, <float>, or <date> element, then you may also nest a single <staticunit> or <dynamicunit> element within the <input> element. If the first child element is an <enum> element, then you may also nest a single <staticunit> element within the <input> element. See “Unit Definitions” below for more details.

Subject to the restrictions noted above for <result> and <input> elements, input and result units may be specified as simple strings or as a list of options in a ‘unit popup list’. Simple unit strings are specified as follows:

<staticunit>[text]</staticunit>

Unit popup lists are specified using the <dynamicunit> element which contains one or more nested <option> units. The syntax of the <dynamicunit> element is show below with required attributes in italics.

```
<dynamicunit default=‘[integer]’>
  <option value=‘[factor]’ label=‘[text]’ />
  ...
</dynamicunit>
```

where the attributes for the <dynamic > element are defined as follows:

default The default selected unit.

and the attributes for the <option> element are interpreted as follows:

label The text displayed in the unit popup list.

value The multiplicative factor applied to each associated value before using the value in the rpn equation (for inputs):

input to RPN equation=user_input* [factor]

converting between values when the user selects a new unit from the unit popup list (for both inputs and results):

converted value=user_input* [new factor]/[current factor]

### EXAMPLE 1

Your RPN equation requires an input in centimeters. You want to allow the user to enter the input value in millimeters, centimeters, or meters. Given the following:

Base unit: cm

1 cm=10 mm

1 cm=0.01 m

The appropriate dynamic unit definition would be:

```
<dynamicunit>
  <option value=‘10’ label=‘mm’ />
  <option value=‘1’ label=‘cm’ />
  <option value=‘0.01’ label=‘m’ />
</dynamicunit>
```

### EXAMPLE 2

Your RPN equation calculates a result in centimeters. You want to be able to display the unit in centimeters or inches. Given the following:

Base unit: cm

cm=0.39 in

The appropriate dynamic unit definition would be:

```
<dynamicunit>
  <option value=‘1’ label=‘cm’ />
  <option value=‘0.39’ label=‘in’ />
</dynamicunit>
```

3 Handheld Drug Interactions Reference

The handheld Drug Interactions Reference is a complementary application that enables users to quickly assess the interaction effects of a list of new drugs (subject drugs) against a list of currently prescribed drugs (object drugs). The application accepts one to many parameters from the Reader 12, denoting any drugs selected to pre-populate the drug list.

The Drug Interactions Reference application 40 evaluates potential interactions based on each drug's pharmacokinetic, pharmacodynamic, and other characteristics. When the characteristics of 2 drugs taken together suggest a possible interaction then the possible interaction, its mechanism and potential severity are presented. All results can be overridden when actual studies suggest a different interaction. The application can also attribute characteristics to entire classes and groups of drugs.

Upon entering the application from the Reader 12, users are prompted to select a list of drugs that contains all subject and object drugs from a quick-search index that allows multiple selections and quick navigation through the drug list as each letter of the drug is spelled out.

After the entire drug list is identified, the user selects with drugs are the subject drugs, i.e. “new” drugs in the patient's drug treatment regimen, and which drugs are object drugs, i.e. “existing” drugs in the patient's drug treatment regimen. To assess the various drug interactions, the application evaluates drug pairs, evaluating each subject drug against each other subject drug and each object drug.

Interactions are presented on a summary screen with abbreviated names, icons and interaction codes, and on a detail result screen where a full-text description of each interaction appears.

What is claimed is

1. A medical reference device comprising:
a. a general purpose computer;
b. the general purpose computer configured with:
1. a plurality of medical and drug information content pages;
2. a reader application, the reader application configured to display medical and drug information content pages and to generate a plurality of parameter strings in response to user-selected medical and drug information;
3. a drug dosing calculator application configured to receive at least one of the parameter strings generated by the reader application and to return dosing information to the reader application.

2. The medical reference device of claim 1, wherein the general purpose computer comprises a portable handheld computer.

3. The medical reference device of claim 2, wherein the portable handheld computer comprises a Palm OS device.

4. The medical reference device of claim 2, wherein the portable handheld computer comprises a Windows OS device.

5. The medical reference device of claim 1, further comprising a document manager application, configured to receive at least one of the plurality of parameter strings generated by the reader application and to provide medical and drug information content pages to the reader application.

6. The medical reference device of claim 5, wherein the document manager application further comprises a generic calculator, and wherein the document manager application is linked to a calculator definition database and calculator look up tables to provide calculator definitions to the generic calculator.

7. The medical reference device of claim 1, wherein the parameter string sent from the reader application to the drug dosing calculator application includes drug dosing parameters corresponding to a user-selected medical condition and a user-selected drug.

8. The medical reference device of claim 1, wherein the parameter string sent from the reader application to the drug dosing calculator application includes drug dosing parameters corresponding to medical and drug information included on a selected medical and drug information content page.

9. The medical reference device of claim 1, wherein the parameter string sent from the reader application to the drug dosing calculator application comprises a plurality of parameter strings.

10. A medical reference device comprising:
a. a general purpose computer;
b. the general purpose computer configured with:
1. a plurality of medical and drug information content pages;
2. a reader application, the reader application configured to display medical and drug information content pages and to generate a plurality of parameter strings in response to user-selected medical and drug information;
3. a document manager application, configured to receive the plurality of parameter strings generated by the reader application and to provide medical and drug information content pages to the reader application.

11. The medical reference device of claim 10, wherein the document manager application is configured to manage an integrated medical and drug information database, including updating and controlling access to medical and drug information content pages.

12. The medical reference device of claim 10, wherein the document manager application is configured to allow access to medical drug information content pages during the time period of a user subscription.

13. The medical reference device of claim 10, wherein the document manager application further comprises a generic calculator, and wherein the document manager application is linked to a calculator definition database and calculator look up tables to provide calculator definitions to the generic calculator.

14. A medical reference device comprising:
a. a general purpose handheld computer;
b. the general purpose handheld computer configured with:
1. a plurality of medical and drug information content pages;
2. a reader application, the reader application configured display medical and drug information content pages and to generate a plurality of parameter strings in response to user-selected medical and drug information;
3. a document manager application, configured to receive the plurality of parameter strings generated by the reader application and to provide medical and drug information content pages to the reader application, wherein the document manager application further comprises a generic calculator, and wherein the document manager application is linked to a calculator definition database and calculator lookup tables to provide calculator definitions to the generic calculator;
4. a drug dosing calculator application configured to receive at least one of the parameter strings generated by the reader application and to return dosing information to the reader application; and
5. a unit conversion calculator configured to receive at least one of the parameter strings generated by the reader application and to return converted units to the reader application.

15. The medical reference device of claim 14, wherein at least one of the plurality of parameter strings includes drug dosing parameters corresponding to medical and drug information included on a selected medical and drug information content page.

16. The medical reference device of claim 14, wherein the parameter string sent from the reader application to the drug dosing calculator application includes drug dosing parameters corresponding to a user-selected medical condition and a user-selected drug.

17. A method for calculating drug dosing using a medical reference device, comprising:
a. configuring the computing device with medical and drug information content pages and a drug dosing calculator;
b. displaying at least one medical and drug information content page on the computing device;
c. selecting a medical condition from a plurality of medical conditions displayed on the computing device based on observations of a patient and displayed medical information;
e. selecting a drug from a plurality of drugs displayed on the computing device;
f. passing drug dosing parameters corresponding to the selected medical condition and the selected drug to the drug dosing calculator; and
g. displaying a calculated drug dose.

18. The method of claim 17, further comprising the step of selecting a method of administering the selected drug and wherein the drug dosing parameters further includes parameters corresponding to the selected method of administering the drug.
